(19) United States
(12) Patent Application Publication
(10) Pub. No.: US 2017/0086282 A1
(43) Pub. Date: Mar. 23, 2017

(54) LED LAMP FOR A VEHICLE AND TESTING METHOD THEREFOR

(71) Applicant: UltraLED Inc., Willis, TX (US)

(72) Inventor: Branden Lee SMELTZER, Montgomery, TX (US)

(73) Assignee: UltraLED Inc., Willis, TX (US)

(21) Appl. No.: 15/267,636

(22) Filed: Sep. 16, 2016

Related U.S. Application Data
(60) Provisional application No. 62/219,939, filed on Sep. 17, 2015.

(51) Int. Cl. H05B 37/03; H05B 33/08; H05B 37/02; B60Q 1/26; F21S 8/10

(52) U.S. Cl. CPC H05B 37/03; B60Q 1/2615; F21S 48/234; F21S 48/215; H05B 37/0227; H05B 33/0851; F21S 48/2212; H05B 33/0884; F21Y 2115/10

(57) ABSTRACT

A vehicle light system includes an LED lamp mounted to an outer body of a vehicle. The LED lamp includes a frame, a diode array having a plurality of individual diodes fixed relative to the frame, and a control unit fixed relative to the frame. The control unit controls a current flow to the diode array and measures a value indicative of the current flow to the diode array. The control unit further compares the measured value to a cut-off value, the cut-off value being a parameter that is indicative of a luminous intensity of the LED lamp. If the measured value is less than the cut-off value, the control unit cuts the current flow to the diode array such that the LED lamp is turned off.

### CROSS-REFERENCE TO RELATED PATENT APPLICATIONS

This application claims the benefit of U.S. Provisional Application No. 62/219,939, filed Sep. 17, 2015, the entire disclosure of which is incorporated herein by reference.

### FIELD

The disclosure relates generally to light emitting diode (LED) lamps for use in vehicles and a testing method therefor.

### BACKGROUND

Various safety standards and regulations govern the use of lamps in motor vehicles. These standards seek to define, for example, the minimum safety performance requirements that a specific lamp must conform in order to be considered compliant and safe for use on roadways. Often, these standards specify certain luminous intensity requirements over various points that a lamp must achieve in order to be considered compliant with the applicable standards.

In some instances, it may be necessary to determine during operation when a lamp no longer meets the applicable safety standards in order to indicate to the driver the need for replacement of the lamp. For a lamp utilizing a traditional single-bulb fixture, such as incandescent or halogen lamps, the lamp will typically meet applicable safety standards up until the bulb burns out and can no longer emit light. Once the bulb has failed, the lamp can no longer function and must be replaced with a new bulb. However, unlike a single-bulb lamp, an LED lamp incorporating an array of multiple individual diodes is capable of emitting light despite the failure of one or more individual diodes. This may make it difficult to consistently and reliably determine the moment when a given LED lamp fails to meet the applicable governing standard during use despite still being capable of emitting light. Simply defining an LED lamp as failing an applicable standard based merely on the number of diodes that have failed is impractical and inaccurate as it may be possible that the LED lamp meets governing standards despite a certain number of failed diodes and, thus, is still compliant for use.

### SUMMARY

In some embodiments, a vehicle light system is disclosed. The vehicle light system includes an LED lamp configured to mount to an outer body of a vehicle. The LED lamp includes a frame, a diode array having a plurality of individual diodes fixed relative to the frame, and a control unit fixed relative to the frame. The control unit is configured to control a current flow to the diode array, measure a value indicative of the current flow to the diode array, and compare the measured value to a cut-off value, the cut-off value being a parameter that is indicative of a luminous intensity of the LED lamp. If the measured value is less than the cut-off value, the control unit is further configured to cut the current flow to the diode array such that the LED lamp is turned off.

In some embodiments, a method for testing an LED lamp for a vehicle is disclosed. The LED lamp includes a frame, a diode array having a plurality of individual diodes fixed relative to the frame, and a control unit fixed relative to the frame. The method includes providing power to the diode array, connecting a testing device to the diode array, the testing device being configured to measure a value indicative of current flow to the diode array, measuring a luminous intensity of the LED lamp at a first distance and a first angle using a measuring device, and determining if the measured luminous intensity is greater than or equal to a threshold luminous intensity. If the measured luminous intensity is determined to be greater than or equal to the threshold luminous intensity, the method further comprises deactivating one individual diode and repeating the steps of measuring the luminous intensity of the LED lamp at the first distance and the first angle and determining if the measured luminous intensity is greater than or equal to the threshold luminous intensity. If the measured luminous intensity is determined to be less than the threshold luminous intensity, the method further comprises measuring the value indicative of the current flow to the diode array using the testing device.

In some embodiments, a vehicle light system is disclosed. The vehicle light system includes an electronic control unit for a vehicle, and an LED lamp configured to mount to an outer body of the vehicle. The LED lamp includes a frame, a diode array having a plurality of individual diodes fixed relative to the frame, and a control unit fixed relative to the frame and in communication with the electronic control unit. The control unit is configured to control a current flow to the diode array, measure a value indicative of the current flow to the diode array, and compare the measured value to a cut-off value, the cut-off value being a parameter that is indicative of a luminous intensity of the LED lamp. If the measured value is less than the cut-off value, the control unit is further configured to communicate to the electronic control unit that the measured value has becomes less than the cut-off value. The electronic control unit is configured to alert a driver of a need for replacement of the LED lamp when the measured value is less than the cut-off value.

### BRIEF DESCRIPTION OF THE DRAWINGS

Features, aspects, and advantages of the present invention will become apparent from the following description and the accompanying exemplary embodiments shown in the drawings, which are briefly described below.

FIGS. 1A-1B are front and side views of an LED lamp according to one embodiment of the present invention.

FIG. 2A-2C are schematic views of the LED lamp of FIGS. 1A-1B.

FIG. 3 is a schematic view of one embodiment of a reflector for use in the LED lamp of FIGS. 1A-1B.

FIG. 4 is a diagram illustrating a testing system of the LED lamp of FIGS. 1A-1B according to one embodiment.

FIG. 5 is a flowchart illustrating a process of the testing system of FIG. 4 according to one embodiment.

FIG. 6 is a diagram illustrating a vehicle system utilizing the LED lamp of FIGS. 1A-1B after being subject to the testing system of FIG. 4, according to one embodiment.

### DETAILED DESCRIPTION

Referring generally to the figures, disclosed herein is an LED lamp, as shown according to exemplary embodiments, for use in motor vehicles and a testing method for determining and programming failure for use in a motor vehicle.

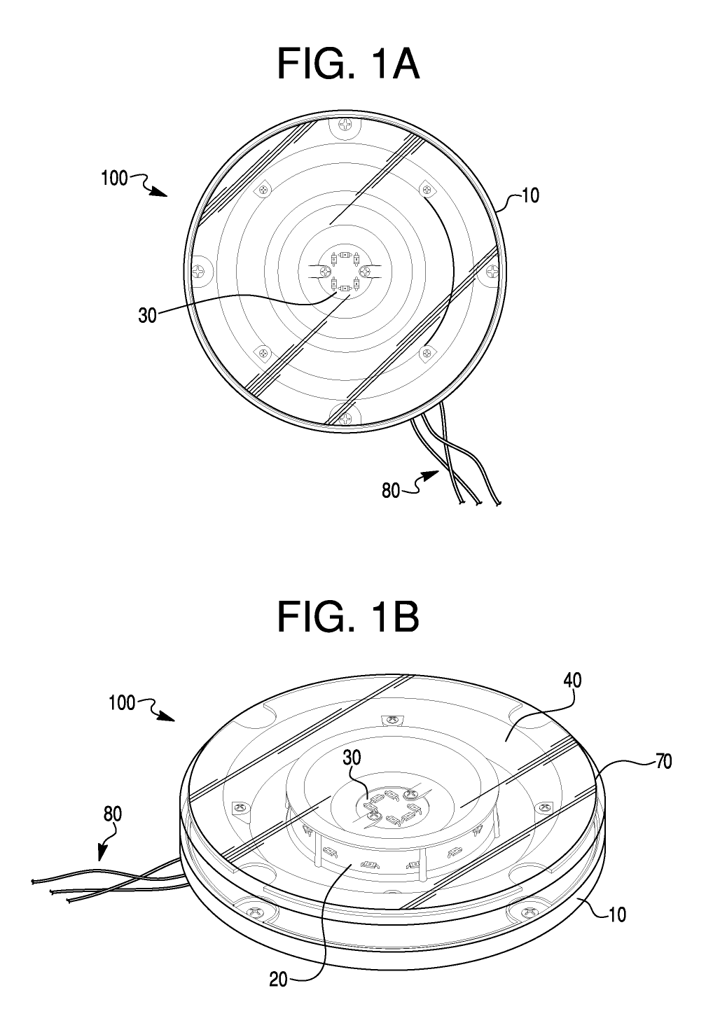

FIGS. 1A-1B illustrate an exemplary embodiment of an LED lamp 100 for a motor vehicle according to the present invention. In general, the LED lamp 100 includes a mounting frame 10, a circuit board 20, a diode array 30 having a plurality of individual diodes, a reflector 40, and a lens 70. The LED lamp 100 is preferably configured to emit light from the diode array 30 in such a way that the light from individual diodes cannot be discerned. In other words, the light emitting from the LED lamp 100 is preferably viewed as a single light source, much like light that is emitted from a single bulb. By emulating a single light source, determining when the LED lamp 100 is no longer compliant with governing standards may be made consistently and reliably. For example, configuring the LED lamp 100 to mimic a single light source may diminish the effect of multiple diodes failing in a specific quadrant of the diode array on luminous intensity at various testing points required by regulations.

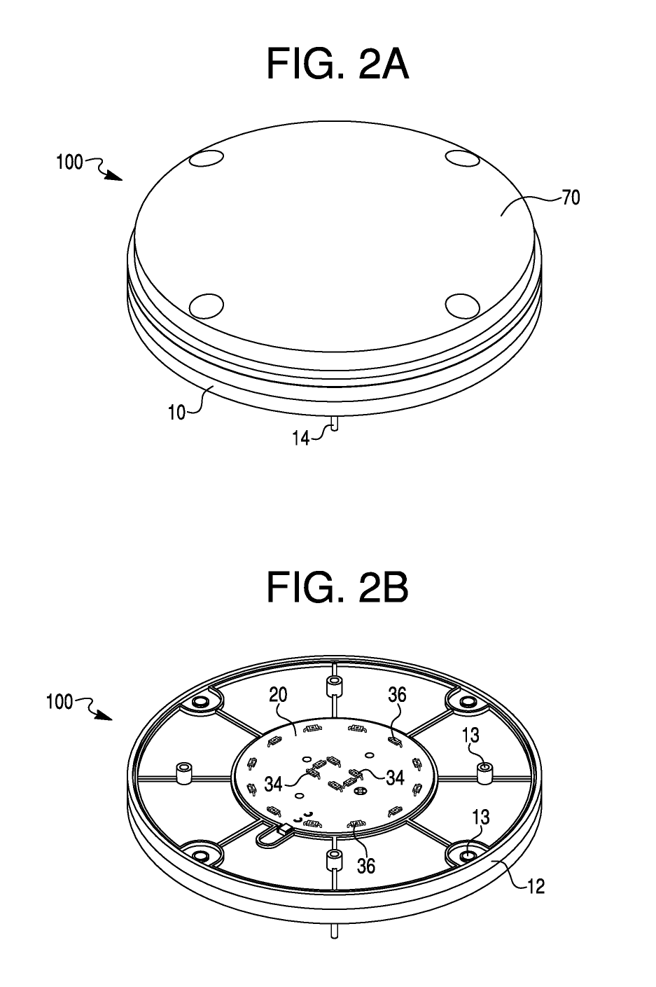

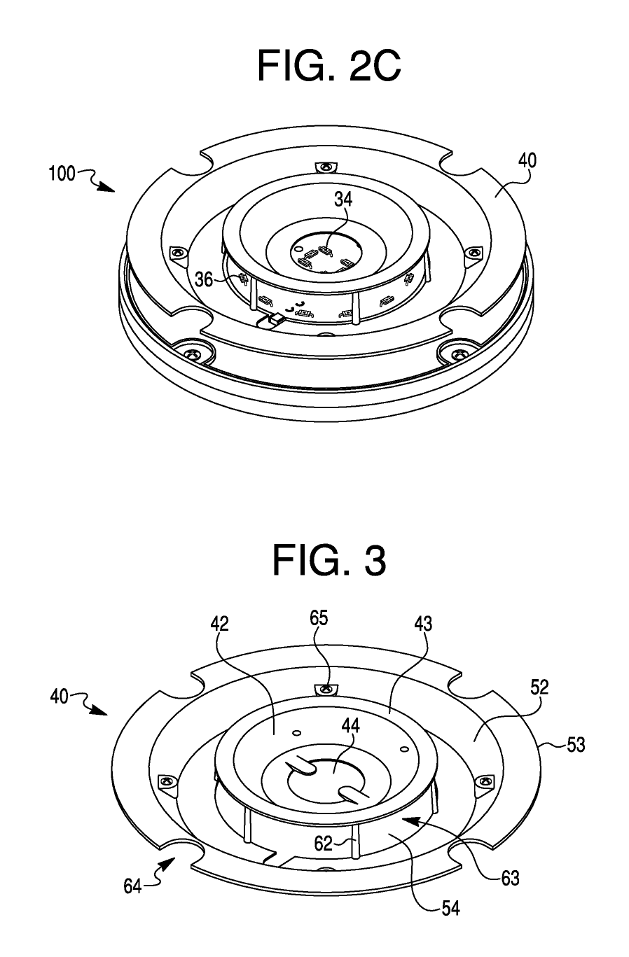

FIGS. 2A-2C illustrate individual components according to one embodiment that contribute to achieving the single light source effect. Specifically, FIG. 2A illustrates the outer components of the LED lamp 100, which includes the lens 70 and the mounting frame 10. The mounting frame may contain projections 14, which may allow the lamp 100 to be mounted to a structure, such as the outer body of a vehicle, by any appropriate means. The lens 70 may be formed of any suitable material that may aid in simulating a single light source, such as a polycarbonate (PC) lens material, and may be shaped in any manner, such as a curved or flat surface.

As shown in FIG. 2B, an inner frame 12 is positioned beneath the lens 70. Mounted centrally within the inner frame 12 is circuit board 20 having the diode array 30 electrically mounted thereon. The circuit board 20 may further include a control unit 500 mounted thereon (not shown). The control unit 500 controls or regulates current flowing to the individual diodes of the diode array 30 from a power source and may be further programmed to measure values indicating current flow, such as amperage draw, ohms, or watts. The diode array 30 may include an outer array 36, which may be positioned along an outer circumference of the circuit board 20. The diode array 30 may further include an inner array 34, which may be grouped in a circular fashion in a center of the circuit board 20. The outer array 36 may include any appropriate number of individual diodes, for example, twelve individual diodes spaced evenly apart. The inner array 34 may also include any appropriate number of individual diodes, for example, six individual diodes spaced evenly apart. Moreover, the placement of the diode array 30 is not limited to the illustrated positioning and may include any appropriate array configuration.

A reflector 40 is mounted to the inner frame 12 and placed so as to partially cover the circuit board 20 and diode array 30. The reflector 40 may be constructed to aid in reflecting light emitted from the individual diodes so as to simulate a single light source. In certain embodiments, the reflector 40 is configured to diffuse light emitted from the individual diodes such that light emitted from the lamp 100 is uniform (i.e., light emitted from individual diodes cannot be discerned). One embodiment of the reflector 40 is shown in FIG. 3. The reflector 40 may include two main structures, an inner reflector 42 and an outer reflector 52. The inner reflector 42 may have a bowl-like shape with a flange 43 extending out and along its outer circumference and a central opening 44 through which the inner diode array 34 is exposed. The outer reflector 52 also may have a bowl-like shape with a flange 53 extending out and along its outer circumference and a central opening 54 to accommodate the circuit board 20, and through which the outer diode array 36 is exposed, but partially covered above by the inner reflector 42 and flange 43. Extending down from the flange 43 of the inner reflector 42 are a plurality of connecting members 62, which connect the inner reflector 42 to a bottom portion of the outer reflector 52. The connecting members 62 are spaced apart along the circumference of the central opening 54 of the outer reflector 52 to form a plurality of side openings 63. The outer reflector 52 may further include a plurality of outer cutouts 64 positioned along the circumference of the flange 53. These cutouts may be shaped to accommodate mounting holes 13 formed in the inner frame 12 (shown in FIG. 2B), which may serve to fix the lens 70 to the inner frame 12 and mounting frame 10 upon assembly. In addition, the outer reflector 52 may further include mounting holes 65 to mount the reflector 40 to the inner frame 12 via additional mounting holes 13.

As shown in FIGS. 1A-1B, wires 80 extend through the bottom of mounting frame 10 to electrically connect to circuit board 20. The wires 80 may further connect to a power source 200 (not shown), which allows power to be fed to the circuit board 20 and allows for illumination of the individual diodes of diode array 30.

Whether an LED lamp 100 is compliant with minimum safety performance requirements, and thus may be operable for use in a motor vehicle, is generally governed by standards set forth by applicable governing bodies. As used herein, applicable governing bodies are those groups that set forth or publish rules, regulations, requirements, and/or protocols regarding lamps, reflective devices, and/or other associated equipment for use in automotive vehicles. In addition, as used herein, a governing standard refers to any generally-accepted rule, regulation, requirement, and/or protocol from the applicable governing body. These governing bodies may include, but are not limited to, the U.S. Department of Transportation, the Society of Automotive Engineers, the Institute of Transportation Engineers, and state or local governments. For example, the Federal Motor Vehicle Safety Standards, administered by the National Highway Traffic Safety Administration of the U.S. Department of Transportation, regulate general design and performance requirements of lamps and reflective devices by requiring such devices to meet minimum luminous intensity requirements at varying distances and angles. Examples of governing standards include Standard No. 108 of the Federal Motor Vehicle Safety Standards and the Society of Automotive Engineers' SAE J Standard, which are incorporated herein by reference in their entireties. A lamp is considered safe for use when its luminous intensity meets or exceeds the minimum governing standard at the required distances and angles.

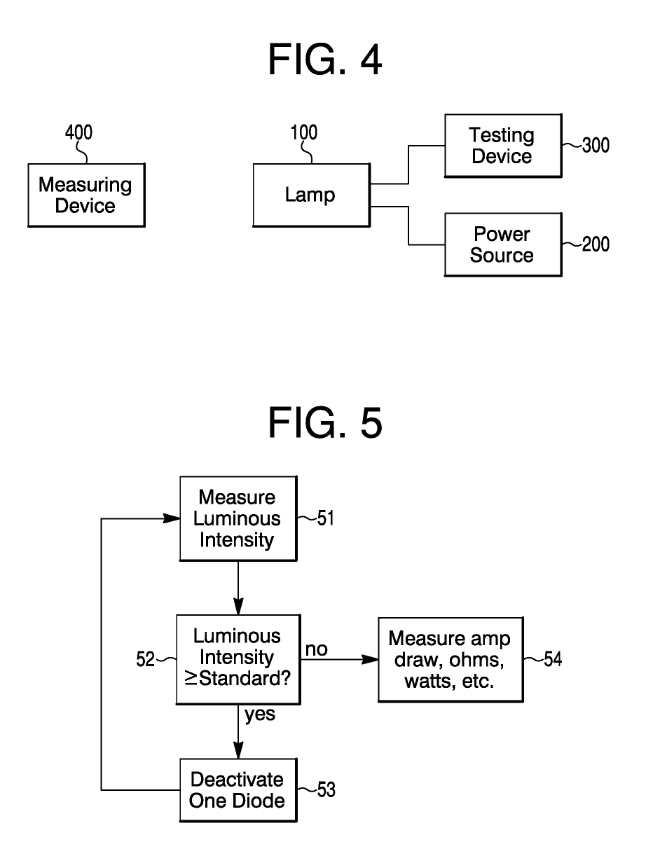

FIG. 4 illustrates one embodiment of a testing system used to establish a cut-off value that indicates when a given LED lamp 100, installed and in use on a motor vehicle, is no longer compliant with the minimum safety performance requirements and thus should be replaced.

The LED lamp 100 to be tested is first connected to a power source 200 to feed power to the circuit board 20 and diode array 30.

In addition, the LED lamp 100 is connected to a testing device 300. The testing device 300 is configured to measure a value of the LED lamp 100 under a variety of conditions that may serve to indicate when the LED lamp 100 no longer passes a standard. These values may include, but are not limited to, ohms, amperage draw, watts, or any combination thereof

A measuring device 400 is positioned away from the LED lamp 100 and may be configured to measure the luminous intensity of the LED lamp 100 during testing. The measuring device 400 may be positioned at a given distance and angle to determine compliance with the requirements of the standard. The measuring device 400 may be further moved and re-positioned to measure the luminous intensity of the LED lamp 100 at a number of test points and distances based on the given standard. Alternatively, the measuring device 400 may be configured to measure other variables that can indicate compliance with other safety performance requirements, such as vibration standards, weather standards, or color standards.

The process in determining a value that is indicative of whether the LED lamp 100 is compliant with safety requirements is illustrated in FIG. 5. Specifically, in S1, the process begins by measuring the luminous intensity of the LED lamp 100 as fully functional (i.e., all individual diodes are on and emitting light). In S1, the measuring device 400 is positioned at a first distance and a first angle and measures the luminous intensity of the LED lamp 100 at this first distance and first angle. In S2, it is determined whether the measured intensity is greater than a threshold luminous intensity, which, in certain embodiments, represents the minimum luminous intensity set by applicable governing standards. If YES, the process proceeds to S3, where one individual diode is deactivated such that it no longer emits light. The process in determining which particular diode is deactivated from the diode array 30 may be any appropriate selection process. For example, the selection process may be random, or a function of diode type or position (e.g., a diode positioned in the inner array or outer array), or the luminous intensity of an individual diode. Once a selected diode is deactivated, the process returns to S1, where measuring the luminous intensity of the LED lamp 100 is performed again. This process is repeated until, at S2, it is determined that the measured luminous intensity no longer passes standards (i.e. the measured luminous intensity is less than the threshold luminous intensity; NO at S2). At this point, the process proceeds to S4, where the testing device 300 is used to measure a parameter or value, such as the amperage draw, ohms, and/or watts, at the current configuration and the measured value is recorded. Alternatively, the testing device 300 may continuously measure the amperage draw, ohms, and/or watts during the testing procedure in order to obtain a plurality of measurements as individual diodes are deactivated.

The process shown in FIG. 5 may then be repeated for a number of distances and/or angles. For example, in certain embodiments, the measuring device 400 is moved to a second distance and/or a second angle, and the measuring device 400 measures a second luminous intensity of the LED lamp with all diodes reactivated and fully functional. The steps S1 to S4 shown in FIG. 5 may then be repeated until the second luminous intensity is measured to be lower than a second threshold luminous intensity, which may represent a minimum luminous intensity set by applicable governing standards for the second distance and/or second angle.

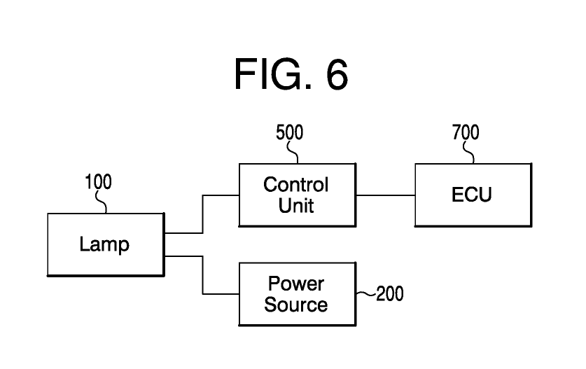

Once the threshold value or values indicating the point in which the LED lamp 100 is no longer compliant with safety standards is determined, the control unit 500 (shown in FIG. 6) is programmed with a cut-off value. During use of the LED lamp 100 in a motor vehicle, this cut-off value serves to indicate to the control unit 500 when current to the diode array 30 should be cut so as to shut off the LED lamp 100 and require replacement. Thus, the LED lamp 100 “burns out” when it no longer passes applicable standards, simulating a single-bulb configuration. The cut-off value programmed into the control unit 500 may match the threshold value or values (e.g., the first threshold luminous intensity and/or the second threshold luminous intensity) measured during the testing of the LED lamp 100 or may be programmed at any appropriate level based on the measured readings documented during testing, such as within 10% of the threshold value. Alternatively, the cut-off value may be programmed to occur when there is a significant change in any of the values measured by the control unit 500. Furthermore, using an LED lamp 100 that simulates a single light source helps in consistently determining whether the LED lamp 100 is no longer compliant with governing standards at various points, even when, for example, multiple diodes fail in a specific quadrant of the array.

FIG. 6 illustrates one embodiment of an LED lamp 100 in service in a vehicle. Once the control unit 500 has been programmed to shut off the LED lamp 100 at the cut-off value, the lamp 100 is mounted to a vehicle structure. Here, the lamp 100 is connected to an appropriate vehicle power source 200. The control unit 500 is configured to continuously measure parameters or values of the diode array 30 that are associated with the cut-off value. The control unit 500 may be further connected to an electronic control unit (ECU) 700 of a vehicle, which may communicate to other vehicle systems. For example, when the control unit 500 shuts off the LED lamp 100, the control unit 500 communicates to the ECU 700 that current is no longer flowing to the lamp 100. The ECU 700 may then communicate to other vehicle systems that can immediately alert the driver to the shut off and the need for replacement. The driver may be notified in any appropriate form, such as a visual indicator (e.g., a dashboard warning light), an auditory indicator, or any other sensory means or combination thereof. Alternatively, the control unit 500 may continue to allow current to flow to the lamp 100 even when the cut-off value is measured. The control unit 500 may simply communicate to the ECU 700 that the cut-off value has been reached, allowing the driver to be alerted that the lamp 100 is close to failing or no longer meeting safety requirements. Thus, the driver may be adequately warned that the lamp 100 should be replaced while still providing a temporary period of use of the lamp 100 until replacement is possible.

In other embodiments, the control unit 500 may be further programmed with a predetermined threshold value that may indicate that the lamp 100 is close to, but not currently failing, safety requirements. The predetermined threshold value may be indicative of a luminous intensity of the LED lamp that is greater than the luminous intensity indicated by the cut-off value. The luminous intensity indicated by the threshold value may be a luminous intensity that is within a certain range of the minimum luminous intensity set by applicable standards (e.g., within 20%, 15%, 10% of the minimum luminous intensity), while the luminous intensity indicated by the cut-off value may be the minimum luminous intensity set by applicable standards. The control unit 500 may then be further configured to communicate to the ECU 700 when that the measured value has become equal to or less than the predetermined threshold value without cutting current to the lamp 100. The ECU 700 may then alert the driver that the lamp 100 has reached its predetermined threshold value, indicating the lamp 100 is close to failing safety requirements and requires replacement. If replacement does not occur, the control unit 500 may then be configured to cut off current to the lamp 100 when the control unit 500 detects that the cut-off value has been reached (i.e, when the lamp 100 is no longer meeting applicable safety standards). The control unit 500 may further be programmed to include a plurality of threshold values that are each indicative of a level of a need for replacement of the lamp 100. The plurality of threshold values may indicate decreasing luminous intensities that are within a certain range of the minimum luminous intensity set by applicable standards (e.g., within 20%, 15%, 10% of the minimum luminous intensity). The control unit 500 may then be configured to communicate to the ECU 700 as each threshold value is reached. The ECU 700 may then alert the driver as each threshold value is reached, each of the alerts indicating to the driver the level of severity of the need for replacement of the lamp 100 (i.e., low, immediate, critical).

The embodiments disclosed herein allow an LED lamp for use in a motor vehicle to be configured to reliably shut down once the luminous intensity of the device fails to pass applicable governing standards. Besides those embodiments depicted in the figures and described in the above description, other embodiments of the present invention are also contemplated. For example, any single feature of one embodiment of the present invention may be used in any other embodiment of the present invention.

Given the disclosure of the present invention, one versed in the art would appreciate that there may be other embodiments and modifications within the scope and spirit of the invention. Accordingly, all modifications attainable by one versed in the art from the present invention within the scope and spirit of the present invention are to be included as further embodiments of the present invention.

What is claimed is:

1. A vehicle light system, the system comprising:
an LED lamp configured to mount to an outer body of a vehicle, the LED lamp comprising:
a frame;
a diode array having a plurality of individual diodes fixed relative to the frame;
a control unit fixed relative to the frame, the control unit configured to:
control a current flow to the diode array;
measure a value indicative of the current flow to the diode array;
compare the measured value to a cut-off value, the cut-off value being a parameter that is indicative of a luminous intensity of the LED lamp,
wherein, if the measured value is less than the cut-off value, the control unit is further configured to cut the current flow to the diode array such that the LED lamp is turned off.

2. The system of claim 1, further comprising a reflector configured to reflect light emitted from the diode array.

3. The system of claim 2, wherein the reflector is further configured to diffuse the light emitted from the diode array such that light emitted from the LED lamp is uniform.

3. The system of claim 1, wherein the measured value is amperage draw.

4. The system of claim 1, wherein the measured value is resistance.

5. The system of claim 1, wherein the measured value is watts.

6. The system of claim 1, wherein the cut-off value is a parameter that is indicative of a minimum luminous intensity set by a governing standard.

7. The system of claim 1, wherein the cut-off value is a parameter that is indicative of a luminous intensity that is 10% greater than a minimum luminous intensity set by a governing standard.

8. The system of claim 1, further comprising:
an electronic control unit of a vehicle, the electronic control unit being in communication with the control unit,
wherein the control unit is further configured to:
compare the measured value to a predetermined threshold value, the predetermined threshold value being indicative of a luminous intensity of the LED lamp that is larger than the luminous intensity indicated by the cut-off value, and
communicate to the electronic control unit that when the measured value becomes equal to or less than the predetermined threshold value, and
wherein the electronic control unit is configured to alert a driver of a need for replacement of the LED lamp when the measured value has become equal to or less than the predetermined threshold value.

9. The system of claim 1, further comprising:
an electronic control unit of a vehicle, the electronic control unit being in communication with the control unit,
wherein the control unit is further configured to:
compare the measured value to a plurality of threshold values, each of the plurality of threshold values being indicative of a luminous intensity of the LED lamp that is larger than the luminous intensity indicated by the cut-off value, and
communicate to the electronic control unit as the measured value becomes equal to or less than each of the plurality of threshold values, and
wherein the electronic control unit is configured to alert a driver of a need for replacement of the LED lamp each time the measured value becomes equal to or less than each of the plurality of threshold values.

10. A method for testing an LED lamp for a vehicle, the LED lamp including a frame, a diode array having a plurality of individual diodes fixed relative to the frame, and a control unit fixed relative to the frame, the method comprising:
providing power to the diode array;
connecting a testing device to the diode array, the testing array configured to measure a value indicative of current flow to the diode array;
measuring a luminous intensity of the LED lamp at a first distance and a first angle using a measuring device; and
determining if the measured luminous intensity is greater than or equal to a threshold luminous intensity,
wherein, if the measured luminous intensity is determined to be greater than or equal to the threshold luminous intensity, the method further comprises deactivating one individual diode and repeating the steps of measuring the luminous intensity of the LED lamp at the first distance and the first angle and determining if the measured luminous intensity is greater than or equal to the threshold luminous intensity, and
wherein, if the measured luminous intensity is determined to be less than the threshold luminous intensity, the method further comprises measuring the value indicative of the current flow to the diode array using the testing device.

11. The method of claim 10, wherein the threshold luminous intensity is a minimum luminous intensity set by a governing standard.

12. The method of claim 10, further comprising:
moving the measuring device to at least one of a second distance or a second angle;
measuring a second luminous intensity of the LED lamp at the at least one of the second distance or the second angle using the measuring device;
determining if the measured second luminous intensity is greater than or equal to a second threshold luminous intensity,
wherein, if the measured second luminous intensity is determined to be greater than or equal to the second threshold luminous intensity, the method further comprises deactivating one individual diode and repeating the steps of measuring the second luminous intensity of the LED lamp at the at least one of the second distance and the second angle and determining if the measured second luminous intensity is greater than or equal to the second threshold luminous intensity, and
wherein, if the measured second luminous intensity is determined to be less than the second threshold luminous intensity, the method further comprises measuring the value indicative of the current flow to the diode array using the testing device.

13. The method of claim 10, further comprising setting a cut-off value in the control unit, the cut-off value being the value indicative of the current flow to the diode array when the measured luminous intensity was determined to be less than the threshold luminous intensity.

14. The method of claim 10, wherein the deactivated individual diode is randomly selected.

15. The method of claim 10, further comprising measuring a plurality of a values indicative of the current flow to the diode array using the testing device.

16. A vehicle light system, the system comprising:
an electronic control unit for a vehicle; and
an LED lamp configured to mount to an outer body of the vehicle, the LED lamp comprising:
a frame;
a diode array having a plurality of individual diodes fixed relative to the frame;
a control unit fixed relative to the frame and in communication with the electronic control unit, the control unit configured to:
control a current flow to the diode array;
measure a value indicative of the current flow to the diode array;
compare the measured value to a cut-off value, the cut-off value being a parameter that is indicative of a luminous intensity of the LED lamp,
wherein, if the measured value is less than the cut-off value, the control unit is further configured to communicate to the electronic control unit that the measured value has becomes less than the cut-off value, and
wherein the electronic control unit is configured to alert a driver of a need for replacement of the LED lamp when the measured value is less than the cut-off value.

17. The system of claim 16, wherein, if the measured value is less than the cut-off value, the control unit is further configured to cut the current flow to the diode array such that the LED lamp is turned off.

18. The system of claim 16, wherein the cut-off value is a parameter that is indicative of a minimum luminous intensity set by a governing standard.

19. The system of claim 16, wherein the cut-off value is a parameter that is indicative of a luminous intensity that is 10% greater than a minimum luminous intensity set by a governing standard.

20. The system of claim 16, wherein the measured value is at least one of amperage draw, resistance, and watts.
